(19) United States
(12) Patent Application Publication
(10) Pub. No.: US 2026/0052005 A1
(43) Pub. Date: Feb. 19, 2026

(54) SYSTEMS AND METHODS FOR SECURE DATA TRANSMISSION USING CRYPTOGRAPHIC ENGINE

(71) Applicant: CRITTORA LLC, New Smyrna Beach, FL (US)

(72) Inventor: Erik Rowan, Ponte Vedra, FL (US)

(73) Assignee: CRITTORA LLC, New Smyrna Beach, FL (US)

(21) Appl. No.: 19/252,794

(22) Filed: Jun. 27, 2025

Related U.S. Application Data
(60) Provisional application No. 63/684,631, filed on Aug. 19, 2024.

(51) Int. Cl. H04L 9/06; H04L 9/32; H04L 9/40

(52) U.S. Cl. CPC H04L 9/0618; H04L 9/3247; H04L 63/0435; H04L 63/0442

(57) ABSTRACT

A method and system for secure data transmission between user devices using a cryptographic engine are disclosed. The method includes obtaining plaintext data for encryption as indicated by an encryption request, generating encrypted data using an encrypting key, and generating a unique encryption identifier associated with the encrypted data. The encryption identifier may be used for referencing one or more cryptographic keys, including the encrypting key, and is used to retrieve key material during decryption. An authentication request including the encryption identifier and access credentials is received and validated. Upon successful validation, the encrypted data is decrypted using a decrypting key and the plaintext data is provided to a user interface. In some embodiments, cryptographic operations are performed locally on the client device. Embodiments may implement symmetric and/or asymmetric encryption for various operations.

### CROSS-REFERENCE TO RELATED APPLICATIONS

This application claims priority to U.S. Provisional Application No. 63/684,631 filed Aug. 19, 2024, which is incorporated by reference in its entirety.

### TECHNICAL FIELD

The present invention relates generally to cryptographic systems and secure data exchange and, more specifically, to a cryptographic engine for facilitating secure transmission of data between two parties by performing registration, encryption, decryption, and digital signature generation and verification processes.

### BACKGROUND

The exponential growth in digital communications has revolutionized how individuals or organizations exchange information. In the contemporary world, the need for secure, efficient, and reliable data transmission between entities has become paramount. As many individuals and organizations increasingly rely on the digital communications to transmit sensitive data, ensuring the security, integrity, and authenticity of the data is critical to prevent unauthorized access, data breaches, and fraud.

Traditional methods of data transmission involve manual processes, which are time-consuming and prone to human error. These methods may also be vulnerable to various security threats, such as interception, tampering, and unauthorized access. Individuals or organizations need a robust system that may automate secure data transmission, thereby ensuring that only authorized users can access the transmitted data, and that the data remains intact and authentic throughout the transmission process.

The process of securing data typically involves encryption, where plaintext data is converted into an unreadable format using cryptographic techniques. Only authorized users with the correct decryption key can convert the encrypted data back into its original plaintext form. However, managing encryption keys and ensuring that only authorized users have access to these keys can be complex and challenging. Further, to ensure the authenticity and integrity of the transmitted data, digital signatures are used.

Traditional encryption methods, such as those provided by key management systems (KMS), offer solutions for securing data. These systems typically involve the use of static encryption keys that are rotated periodically, often annually, as per the National Institute of Standards and Technology (NIST) guidelines. However, these traditional encryption methods present several limitations and vulnerabilities.

Traditional systems utilize a single encryption key for multiple transactions over a long period, increasing the risk of key compromise and subsequent data breaches. Infrequent key rotation does not align with the dynamic nature of modern data transactions, where the volume and frequency of data exchanges are continually increasing. This creates a need for a more flexible and secure approach to data encryption. Additionally, the storage of encryption keys in close proximity to the encrypted data poses an additional security risk. An attacker gaining access to one system can potentially access both the keys and the encrypted data, leading to significant vulnerabilities.

Further, conventional methods do not provide a mechanism to ensure the security of each individual transaction. This is particularly critical in environments where the integrity and authenticity of data transactions are essential. Furthermore, traditional digital signature methods often rely on static keys, which can be reused, potentially compromising the authenticity of multiple transactions if a key is compromised.

Accordingly, there is a need for a solution to the aforementioned problems. For example, there exists a need for a cryptographic secure data exchange method. Further, there is a need for a cryptographic engine that facilitates secure registration, encryption, decryption, and digital signature generation and verification processes.

### SUMMARY

According to an implementation of the present disclosure, there is provided a method for secure data transmission between a first user device and a second user device. The method comprises receiving, by a cryptographic engine, one or more inputs from the first user device associated with a first user, wherein the one or more inputs comprise data to be encrypted and a unique identifier of a second user associated with the second user device to access the data and generating, by the cryptographic engine, encrypted data from at least the received inputs. The method further comprises transmitting, by the cryptographic engine, the encrypted data and a first transaction ID associated with the encrypted data to the first user device, wherein the first user device sends the transmitted encrypted data and the first transaction ID to the second user device. The method also comprises validating, by the cryptographic engine, permission for the second user to access the data corresponding to the encrypted data, wherein the permission is validated upon receiving an authentication request from the second user device, decrypting, by the cryptographic engine, the encrypted data using the first transaction ID when the permission is validated and sending the decrypted data to the second user device.

In an aspect, wherein validating the permission for the second user may comprise receiving, by the cryptographic engine, the authentication request from the second user device, wherein the authentication request includes the first transaction ID and credentials of the second user and verifying, by the cryptographic engine, the credentials of the second user against a stored list of authorized users associated with the first transaction ID.

In an aspect, wherein decrypting the encrypted data using the first transaction ID may comprise retrieving, by the cryptographic engine, a key used to encrypt the data using the first transaction ID received from the second user device, wherein the key and the first transaction ID are stored as a single record in a database and decrypting, by the cryptographic engine, the encrypted data using the retrieved key.

In an aspect, the method may further comprise generating, by the cryptographic engine, a digital signature for the data, wherein the generated digital signature is stored in the database along with a second transaction ID associated with the generated digital signature, and wherein the generated digital signature and the second transaction ID are transmitted along with the encrypted data.

In an aspect, wherein the digital signature may be generated using public key cryptography, wherein a private key used to generate the digital signature may be destroyed upon generating the digital signature, and wherein a public key associated with the private key may be stored along with the second transaction ID in the database.

In an aspect, the method may further comprise verifying, by the cryptographic engine, the digital signature when the digital signature is received from the second user device along with the second transaction ID.

In an aspect, wherein verifying the digital signature may comprise retrieving, by the cryptographic engine, the public key stored along with the second transaction ID from the database and verifying, by the cryptographic engine, the digital signature using the retrieved public key.

In an aspect, wherein the encrypted data may be decrypted upon verifying the digital signature for the data.

In an aspect, wherein the encrypted data may be sent from the first user device to the second user device via a secure communication channel.

In an aspect, wherein the one or more inputs may be received upon authenticating the first user, and wherein the first user may be authenticated upon receiving login credentials from the first user device.

In an aspect, the method may further comprise receiving, by the cryptographic engine, a request from the first user device to create a partner account for the second user; creating, by the cryptographic engine, the partner account for the second user based on the received request; and sending, by the cryptographic engine, login credentials for the second user to the first user device upon creating the partner account for the second user, wherein the first user device sends the login credentials to the second user device, wherein the login credentials are used by the second user to access the cryptographic engine.

According to another implementation of the present disclosure, there is provided a device to securely transmit data between a first user device and a second user device. The device comprises a memory to store instructions and a processor coupled to the memory. The processor is configured to receive one or more inputs from the first user device associated with a first user, wherein the one or more inputs comprise data to be encrypted and a unique identifier of a second user associated with the second user device to access the data and generate encrypted data from at least the received inputs. The processor is further configured to transmit the encrypted data, and a first transaction ID associated with the encrypted data to the first user device, wherein the first user device sends the transmitted encrypted data and the first transaction ID to the second user device. The processor is also configured to validate permission for the second user to access the data corresponding to the encrypted data, wherein the permission is validated upon receiving an authentication request from the second user device; decrypt the encrypted data using the first transaction ID when the permission is validated; and send the decrypted data to the second user device.

Embodiments may include a method for secure data transmission between user devices, the method including: obtaining, by a processor executing a cryptographic engine, plaintext data for encryption as indicated by an encryption request; generating, by the processor, encrypted data from the plaintext data using an encrypting key by executing a cryptographic operation; generating, by the processor, a unique encryption identifier associated with the encrypted data, the unique encryption identifier for referencing one or more cryptographic keys including the encrypting key; receiving, by the processor, an authentication request via a user interface, the authentication request indicating the unique encryption identifier and a set of access credentials; in response to the processor validating the set of access credentials against a stored access permission record associated with the unique encryption identifier: decrypting, by the processor, the encrypted data to recover the plaintext data by executing the cryptographic operation of the cryptographic engine using a decrypting key of the one or more cryptographic keys indicated by the unique encryption identifier; and providing, by the processor, the plaintext data to the user interface.

In some aspects, the techniques described herein relate to a method, further including storing, by the processor, the unique encryption identifier and the encrypting key in a data repository.

In some aspects, the techniques described herein relate to a method, further including retrieving, by the processor, the decrypting key from a data repository based on the unique encryption identifier as indicated by the authentication request.

In some aspects, the techniques described herein relate to a method, wherein the encrypting key and the decrypting key are a same symmetric key.

In some aspects, the techniques described herein relate to a method, wherein the cryptographic operation includes an Advanced Encryption Standard (AES) algorithm.

In some aspects, the techniques described herein relate to a method, wherein the encrypting key is a private key of an asymmetric key pair and the decrypting key is a public key of the asymmetric key pair.

In some aspects, the techniques described herein relate to a method, further including generating, by the processor, a digital signature for the plaintext data using a private key; and deleting, by the processor, the private key after the digital signature is generated.

In some aspects, the techniques described herein relate to a method, wherein the authentication request includes a digital signature, and wherein validating the set of access credentials includes verifying, by the processor, the digital signature of the authentication request using a public key associated with a private key.

In some aspects, the techniques described herein relate to a method, wherein the processor executing the cryptographic engine is executed on a first user device.

In some aspects, the techniques described herein relate to a method, wherein the encrypted data is transmitted from a first user device to a second user device via a secure communication channel.

Embodiments may include a system for secure data transmission between user devices, the system including: a processor configured to: obtain plaintext data for encryption as indicated by an encryption request; generate encrypted data from the plaintext data using an encrypting key by executing a cryptographic operation; generate a unique encryption identifier associated with the encrypted data, the unique encryption identifier referencing one or more cryptographic keys including the encrypting key; receive an authentication request via a user interface, the authentication request indicating the unique encryption identifier and a set of access credentials; in response to validating the set of access credentials against a stored access permission record associated with the unique encryption identifier: decrypt the encrypted data to recover the plaintext data by executing the cryptographic operation using a decrypting key of the one or more cryptographic keys indicated by the unique encryption identifier; and provide the plaintext data to the user interface.

In some aspects, the techniques described herein relate to a system, wherein the processor is further configured to store the unique encryption identifier and the encrypting key in a data repository.

In some aspects, the techniques described herein relate to a system, wherein the processor is further configured to retrieve the decrypting key from a data repository based on the unique encryption identifier as indicated by the authentication request.

In some aspects, the techniques described herein relate to a system, wherein the encrypting key and the decrypting key are a same symmetric key.

In some aspects, the techniques described herein relate to a system, wherein the cryptographic operation includes an Advanced Encryption Standard (AES) algorithm.

In some aspects, the techniques described herein relate to a system, wherein the encrypting key is a private key of an asymmetric key pair and the decrypting key is a public key of the asymmetric key pair.

In some aspects, the techniques described herein relate to a system, wherein the processor is further configured to: generate a digital signature for the plaintext data using a private key; and delete the private key after the digital signature is generated.

In some aspects, the techniques described herein relate to a system, wherein the authentication request includes a digital signature, and wherein the processor is further configured to validate the set of access credentials by verifying the digital signature using a public key associated with a private key.

In some aspects, the techniques described herein relate to a system, wherein the processor executing the cryptographic engine is located on a first user device.

In some aspects, the techniques described herein relate to a system, wherein the encrypted data is transmitted from a first user device to a second user device via a secure communication channel.

The device and associated method of the present disclosure overcome one or more of the shortcomings of the prior art. Additional features and advantages may be realized through the techniques of the present disclosure. Other embodiments and aspects of the disclosure are described in detail herein and are considered a part of the claimed disclosure.

These and other objects, features, and advantages of the present invention will become more readily apparent from the attached drawings and the detailed description of the preferred embodiments, which follow.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views. The preferred embodiments will hereinafter be described in conjunction with the appended drawings provided to illustrate and not to limit the described aspects.

FIG. 1 shows an example secure data transmission system in accordance with some embodiments of the present disclosure.

FIG. 2 shows a detailed block diagram illustrating the cryptographic engine in accordance with some embodiments of the present disclosure.

FIG. 3 is a flow diagram of an example secure data transmission method in accordance with some embodiments of the present disclosure.

FIG. 4 shows a flowchart detailing the process of secure data transmission using the cryptographic engine in accordance with some embodiments of the present disclosure.

FIG. 5 shows a schematic representation of an example computer-readable storage medium in accordance with some embodiments of the present disclosure.

FIG. 6 shows an exemplary table record stored in a database in accordance with some embodiments of the present disclosure.

FIG. 7 shows another exemplary table record stored in a database in accordance with some embodiments of the present disclosure.

FIG. 8 is a flowchart of an example method for secure data transmission between a first user device and a second user device in accordance with some embodiments of the present disclosure.

FIG. 9 is a flowchart of an example method for retrieving and decrypting encrypted data to recover the original plaintext in accordance with some embodiments of the present disclosure.

FIG. 10 is a flowchart of an example method for secure data transmission between a first user device and a second user device.

Like reference numerals refer to like parts throughout the several views of the drawings.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

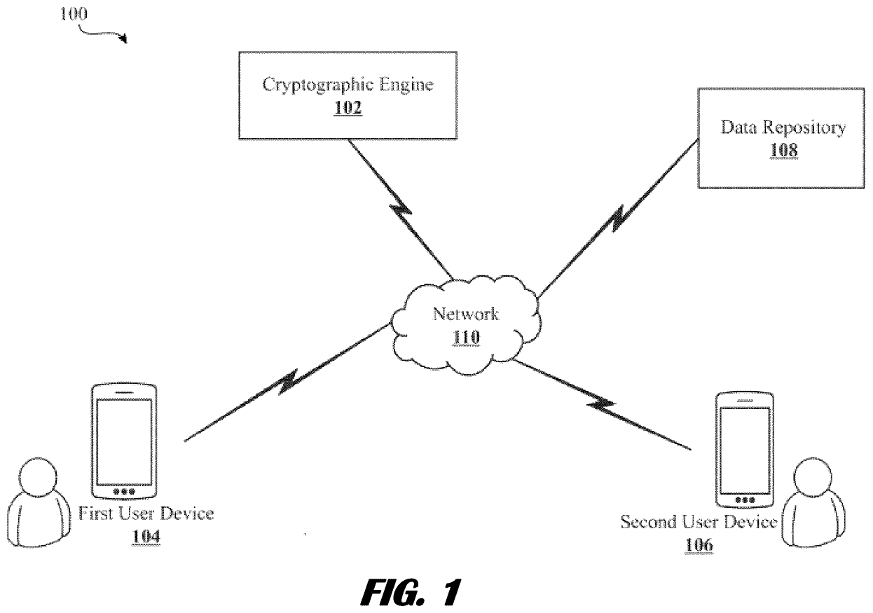

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

The present disclosure describes a cryptographic system designed to enhance the security, integrity, and authenticity of data exchanged between user devices. A cryptographic engine of one or more computing devices performs key management, encryption, decryption, and digital signature operations. A cryptographic engine may be deployed in a cloud-based environment, on a client device, or in a hybrid configuration. For instance, in some embodiments, a user device executes a cryptographic engine (e.g., compiled into WebAssembly) and executed locally within a browser, enabling high-performance cryptographic operations without exposing plaintext data to external systems.

The system introduces a dynamic, per-request encryption model. For each encryption request, a cryptographic engine generates a unique encryption identifier (ID) (sometimes referred to herein as an “encryption request ID” or “transaction ID”), which serves as a reference to retrieve the associated cryptographic keys.

In various embodiments, the cryptographic engine described herein may be used to protect plaintext data and/or encryption material itself, such as a data encryption key (DEK). The system may encrypt and store the DEK using a key encryption key (KEK), such that even the key used to encrypt sensitive data is itself protected. This layered approach to encryption enhances the overall security posture of the system by minimizing the risk of key compromise and enabling secure key rotation, revocation, and auditability.

As mentioned, the system may be configured to protect plaintext data, encryption material, or both, depending on the use case. For example, in a client-side embodiment, the plaintext data may be encrypted locally using a DEK, and only the encrypted DEK and associated metadata are transmitted to a remote server. In other embodiments, the system may be used to securely store and manage DEKs without ever handling the underlying plaintext data. This flexibility allows the cryptographic engine to serve as a secure key management layer, a data protection layer, or both, depending on the needs of the application and the sensitivity of the data involved. The DEK is generated to encrypt the plaintext data and the KEK is used to encrypt the DEK before storage or transmission. In some embodiments, the DEK is encrypted locally and only the encrypted DEK and encryption identifier are transmitted to a remote server, such that plaintext data never leaves the local device.

Optionally, to support data authenticity, the system may generate a digital signature using a key signing key (KSK). The private key used for signing is destroyed immediately after use, and only the public key and associated metadata are retained for verification.

Access to encrypted data (e.g., encrypted ciphertext of original plaintext, encrypted DEK) is controlled through a permission validation process, which may include credential-based authentication and verification of access rights associated with the encryption identifier.

In some embodiments, a comprehensive cryptographic system may enhance the security of data exchange between a first user device and a second user device. The cryptographic system comprises a cryptographic engine that may comprise various modules such as a registration module for secure user and device registration, an encryption and decryption module for ensuring data confidentiality during transmission, and a signature generation and verification module for maintaining data integrity and authenticity. The cryptographic engine may implement a process that begins with the first user device associated with a first user submitting data, which is encrypted and linked to a unique transaction ID before being sent to the second user device. The second user device requests access to the encrypted data, triggering a permission validation process. Upon successful validation, the data is decrypted using the transaction ID. Further, digital signatures are generated for data authenticity and integrity, with a private key immediately destroyed after use to prevent misuse. The data is decrypted, and the signatures are verified to confirm legitimacy and secure access. Thus, by implementing the cryptographic engine, data exchange security is enhanced, making the present disclosure ideal for applications requiring stringent data protection measures such as financial services, healthcare, and secure communications.

FIG. 1 shows an example secure data transmission system 100 in accordance with some embodiments of the present disclosure. As illustrated in FIG. 1, the example secure data transmission system 100 comprises a cryptographic engine 102, a first user device 104, a second user device 106, and a data repository 108. The cryptographic engine 102, the first user device 104, the second user device 106, and the data repository 108 are coupled via a network 110. In some embodiments, the cryptographic engine 102 may be implemented on a remote server, a local device, or both, depending on whether the encryption and decryption operations are performed in a cloud-based or client-side configuration.

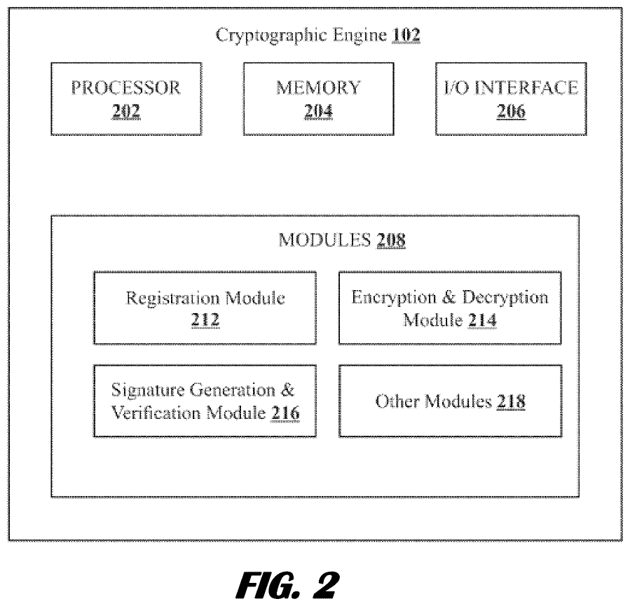

The secure data transmission system 100 comprises the cryptographic engine 102, a central component responsible for performing one or more cryptographic operations to securely transmit data between one or more user devices. As will be discussed in detail in relation to FIG. 2, the cryptographic engine 102 comprises several key components that work in harmony to efficiently transmit the data between the first user device 104 and the second user device 106 by performing one or more cryptographic operations such as encryption, decryption, digital signature generation, and verification. In some embodiments, the cryptographic engine 102 may be compiled into WebAssembly and executed directly in a browser environment on the user device to support high-performance local encryption without exposing plaintext data to the server.

Further, the secure data transmission system 100 comprises the first user device 104 and the second user device 106. The first user device 104 and the second user device 106 comprise an integrated platform, which is a gateway for the first user device 104 and the second user device 106 to engage with the cryptographic engine 102. The integrated platform may support both server-mediated and local-only workflows, depending on the deployment model.

In some embodiments, a first user associated with the first user device 104 may need to send data to a second user associated with the second user device 106. In order to send the data, the first user may register with the cryptographic engine 102 and add the second user associated with the second user device 106 as a partner for the first user. Upon adding the second user as the partner, the cryptographic engine 102 may send login credentials associated with the second user to the first user device 104. Upon adding the second user as the partner, the first user using the first user device 104 may send data to the cryptographic engine 102 using the integrated platform for securely transmitting the data to the second user device 106. Similarly, the first user associated with the first user device 104 may also receive data from the second user device 106 using the cryptographic engine 102. In some embodiment, the first user device 104 serves as the interface through which the first user interacts with the cryptographic engine 102. Similarly, the second user device 106 serves as the interface through which the second user interacts with the cryptographic engine 102. In some embodiments, the first user may be associated with a first organization and the second user may be associated with a second organization. In a client-side embodiment, the encryption key may be generated and used locally, and only encrypted key material and metadata are transmitted to the server, if at all.

In some embodiments, the integrated platform may be a software application installed in the first user device 104 or the second user device 106, a web application that may be accessed through a web browser associated with the first user device 104 or the second user device 106, or an Original Equipment Manufacturer (OEM) software. The first user device 104 or the second user device 106 may be any electronic device such as a desktop computer, laptop computer, portable or mobile device, cell phone, smartphone, tablet computer, personal digital assistant (PDA), wearable device, or the like. In some embodiments, the cryptographic engine may be embedded in the integrated platform and operate independently of the server, particularly in privacy-sensitive applications.

The secure data transmission system 100 also comprises the data repository 108. The data repository 108 is configured to store registration information related to one or more users registered with the cryptographic engine 102 and also one or more partner's information associated with each registered user. Further, the data repository 108 is configured to maintain a transaction record for each data sent from the first user device 104 or the second user device 106. In some embodiments, the transaction record may comprise an encryption request identifier and a key used for encrypting the data sent from the first user device 104 or the second user device 106. The encryption request identifier may be a randomly generated or pseudorandom string that uniquely identifies each encryption event and is used to retrieve the corresponding encrypted key material.

Further, in some other embodiments, the data repository 108 is also configured to maintain a transaction record for each digital signature generated for the data sent from the first user device 104 or the second user device 106. The transaction record may comprise an encryption request identifier and a public key to be used for validating the digital signature generated. In some embodiments, the data repository 108 may be integrated within the cryptographic engine 102, the first user device 104, and the second user device 106. In another embodiment, the data repository 108 may be a standalone repository communicatively coupled with the cryptographic engine 102, the first user device 104, and the second user device 106 over the network 110. In some implementations, the private key used to generate the digital signature is destroyed immediately after use, and only the public key and associated metadata are retained.

The secure data transmission system 100 also comprises the network 110 that may be a LAN (local area network), WAN (wide area network), wireless network, point-to-point network, or another configuration. One of the most common types of the network 110 in current usis a TCP/IP (Transfer Control Protocol and Internet Protocol) network for communication between different devices. Other common Internet protocols used for such communication include HTTPS, FTP, AFS, and WAP and using secure communication protocols etc. In some embodiments, the network 110 may be any type of communication network, including one or more of the Internet, local area networks (LAN), wireless networks, switch or hub connections, a telephone network (e.g., a public switched telephone (PSTN) network, a cellular network, or the like), or the like.

It is to be noted that though FIG. 1 shows a single cryptographic engine 102, a single first user device 104, a single second user device 106, and a single data repository 108; a person skilled in the art would appreciate the secure data transmission system 100 may comprise a plurality of such devices, which are not shown herein for the sake of brevity.

FIG. 2 shows a detailed block diagram illustrating the cryptographic engine 102 in accordance with some embodiments of the present disclosure. The cryptographic engine 102 is a component of the secure data transmission system 100 and is configured to perform cryptographic operations such as encryption, decryption, digital signature generation, and digital signature verification. In some embodiments, the cryptographic engine 102 may be implemented on a remote server, a local device, or both. In client-side embodiments, the cryptographic engine 102 may be compiled into, for example, WebAssembly, and executed within a browser environment to perform cryptographic operations locally, without transmitting plaintext data to a remote server.

The cryptographic engine 102 is a component within the secure data transmission system 100, designed to execute all cryptographic operations to ensure the secure exchange of data between the first user device 104 and the second user device 106. In an implementation, the cryptographic engine 102 may comprise a processor 202, a memory 204, an I/O interface 206, and one or more modules 208. In some embodiments, the cryptographic engine 102 may be implemented on a remote server, a local device, or both. In some embodiments, the cryptographic engine 102 may be compiled into WebAssembly and executed within a browser environment on the user device.

The processor 202 may be configured to perform one or more functions to fulfill one or more requirements of the cryptographic engine 102. The memory 204 may be communicatively coupled to the processor 202 and may store information related to the one or more users registered with the cryptographic engine 102. The I/O interface 206 may be configured to enable the cryptographic engine 102 to communicate with the integrated platform associated with one or more devices, such as the first user device 104, the second user device 106, or any external device.

In some implementations, the cryptographic engine 102 may comprise the one or more modules 208 for performing various operations in accordance with some embodiments of the present disclosure. In some embodiments, the one or more modules 208 may be stored as a part of the processor 202. In some other embodiments, the one or more modules 208 may be communicatively coupled to the processor 202 to perform one or more functions of the cryptographic engine 102. The one or more modules 208 may comprise, without limiting to, a registration module 212, an encryption and decryption module 214, a signature generation and verification module 216, and other modules 218.

As used herein, the term module refers to an application-specific integrated circuit (ASIC), an electronic circuit, a processor (shared, dedicated, or group) and memory that executes one or more software or firmware programs, a combinational logic circuit, and/or other suitable components that provide the described functionality. In an embodiment, the other modules 218 may be used to perform various miscellaneous functionalities of the cryptographic engine 102. It would be appreciated that such other modules 218 may be represented as a single module or a combination of different modules.

In some examples, the processor 202 may comprise at least one controller in communication with at least one non-transitory processor-readable medium. The processor-readable medium may have instructions stored thereon which when executed cause the processors to perform or control performance of the operations as described herein. Furthermore, in some examples, the processor 202 or its functionality may be implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

The one or more modules 208 comprises the registration module 212. The registration module 212 is configured to register accounts for one or more users with the cryptographic engine 102 and manage the registered accounts to enable one or more registered users to participate in secure data transmission.

In some embodiments, the registration module 212 is configured to allow one or more users (such as the first user associated with the first user device 104) to create an account for themselves and for one or more partners for whom the first user may need to send the data (such as the second user associated with the second user device 106). During the registration process, the registration module 212 is configured to collect necessary information such as username, email address, and other unique identifiers associated with the first user. This information is securely stored in the data repository 108. Upon registering the first user, the registration module 212 is configured to generate unique login credentials for the first user. Further, in some embodiments, the registration module 212 is configured to allow the first user to register the second user. For instance, when the registration module 212 receives a request from the first user device 104 to create a partner account for the second user, the registration module 212 processes the request by generating login credentials for the second user. In some embodiments, the login credentials may comprise a username and a temporary password, which the first user device 104 may securely transmit to the second user device 106. The second user may then use these credentials for the first time and set up the second user's own secure password. In some embodiments, the registration module 212 may also support permission assignment for access to encrypted data.

The registration module 212 is also configured to manage the ongoing authentication of users. When a user attempts to log in, the registration module 212 is configured to verify the login credentials against the stored information in the data repository 108. In some embodiments, verifying the login credentials comprises checking the provided username and password to ensure they match the records in the data repository 108. If the credentials are valid, the user is granted access to the cryptographic engine 102.

Further, in some embodiments, the registration module 212 is configured to support multi-factor authentication (MFA), in which the one or more users may be required to provide an additional verification code sent to their registered email or phone number, thereby ensuring an additional layer of security to perform cryptographic operations. As an example, in some embodiments, the registration module 212 may implement OAuth2 authentication or the like.

Further, in some other embodiments, the registration module 212 is configured to manage access control and permission management. For example, when the first user registers the second user, the registration module 212 is configured to enable the first user to specify the permissions and access levels for that second user which may include defining which encrypted data the second user can access and what operations the second user is allowed to perform (e.g., read, write, decrypt). In some embodiments, permission validation need not apply in client-side embodiments where the encryption key is never shared.

In some embodiments, the cryptographic engine 102 further comprises or interacts with a permission access record that is used to control access to encrypted data. The record may be created by the registration module 212 or the encryption and decryption module 214, depending on the implementation. This record is generated during the encryption process, typically at the time an encryption request is initiated by the first user device 104. The permission access record is associated with the unique encryption identifier (e.g., encryption request ID) generated for that encryption event.

The permission access record includes, for example, various types of data or metadata that identifies which users or user devices are authorized to access the encrypted data. This data may include user identifiers (e.g., usernames, email addresses, or device IDs), access levels (e.g., read, write, decrypt), and optional expiration timestamps or usage limits. In some embodiments, the permission access record may also include cryptographic credentials or references to public keys used for digital signature verification. The record may be stored in the data repository 108, either as a standalone entry or as part of a composite record that includes the encryption identifier and encrypted key material.

When a second user device 106 submits an authentication request to access encrypted data, the encryption and decryption module 214 retrieves the corresponding permission access record using the encryption identifier provided in the request. The module 214 then validates the request by comparing the submitted credentials (e.g., login token, digital signature, or user ID) against the authorized entries in the permission access record. If the credentials match and the access conditions are satisfied, the module 214 proceeds to retrieve the appropriate decryption key and decrypt the data.

The one or more modules 208 also comprises the encryption and decryption module 214, which is configured to transform plaintext data into encrypted data and vice versa. The encryption and decryption module 214 is configured to receive one or more inputs from the first user device 104. In some embodiments, the one or more inputs may include data to be encrypted and unique identifiers associated with the second users who are authorized to access this data.

Upon receiving the data to be encrypted and the unique identifiers, the encryption and decryption module 214 is configured to transform the plaintext data into encrypted data using one or more encryption algorithms. In some embodiments, the one or more encryption algorithms may comprise symmetric key encryption algorithms such as Advanced Encryption Standard (AES). In some other embodiments, the one or more encryption algorithms may comprise asymmetric key encryption algorithms such as Rivest, Shamir, Adleman (RSA). In some embodiments, the encryption and decryption module 214 is configured to generate an encryption request identifier (sometimes referred to as a “transaction ID” or “encryption ID” herein) associated with the various types of encrypted data.

Further, upon generating the encrypted data, the encryption and decryption module 214 is configured to generate the unique transaction ID associated with the encrypted data. In some embodiments, the unique transaction ID (or “encryption identifier) serves as a reference for referencing, tracking, and managing the encrypted data (e.g., encrypted plaintext, encrypted DEK), including during decryption and access validation. In some embodiments, for example, the encryption and decryption module 214 (or other software component) may generate the unique transaction ID by executing or invoking software routines of a random number generator or pseudo-random number generator.

In some embodiments, the encryption request identifier is a unique identifier that is stored in association with the encrypted data and the encryption key used to encrypt the data. The encryption request identifier may be used to retrieve the corresponding encrypted key material during decryption.

In some embodiments, the encryption and decryption module 214 enables an encryption key, along with the generated transaction ID, to be stored securely within the data repository 108. Upon storing the transaction ID, the encrypted data and the transaction ID are transmitted to the first user device 104, who may then forward it to the second user device 106 via a secure communication channel.

Further, in some embodiments, the encrypted data is deleted immediately after storing the transaction ID. By immediately deleting the encrypted data, an attacker may not have access to both the encrypted data and the encryption key in the same place, if the cryptographic engine 102 is compromised.

In some embodiments, the encryption and decryption module 214 is configured to receive an authentication request from the second user device 106_when the second user attempts to access the encrypted data received from the first user device 104. In some embodiments, the authentication request may comprise the transaction ID associated with the encrypted data and the second user's credentials, which are used to validate the second user's authorization to access the data.

In some embodiments, the encryption and decryption module 214 is configured to validate the second user's permissions by verifying the credentials against a stored list of authorized users associated with the transaction ID. If the credentials and permissions are valid, the decryption process may be initiated. Upon successful validation, the encryption and decryption module 214 is configured to retrieve a decryption key associated with the transaction ID from the data repository 108. The decryption key is required for converting the encrypted data back into its original plaintext form.

Upon retrieving the decryption key, the encryption and decryption module 214 is configured to decrypt the encrypted data back into readable plaintext using the decryption key. The encryption and decryption module 214 (or other software of a cryptographic engine) uses the decryption key, thereby producing or recovering the plaintext data as the decrypted data. The decrypted data is then accessible to the authorized second user, thereby ensuring that only users with the correct permissions view the sensitive information of the decrypted data.

In some embodiments, the cryptographic engine 102 is configured to protect both plaintext data and the encryption material used to secure that data. The encryption and decryption module 214 may generate a data encryption key (DEK) to encrypt the plaintext data and then encrypt the DEK itself using a key encryption key (KEK). This approach introduces a layered security model in which the DEK is treated as sensitive material and is protected independently of the data it encrypts. The processor 202 and memory 204 may cooperate to perform these operations and store intermediate key material, while the I/O interface 206 facilitates communication with external systems or user devices such as the first user device 104 and second user device 106.

The cryptographic engine 102 may be deployed in configurations where only the encrypted DEK is transmitted from an originating device (e.g., first user device 104) to a remote server, such as the cryptographic engine 102 operating in a cloud-based environment, while the plaintext data remains local to the originating device (e.g., first user device 104). In such cases, the KEK is retained locally and used later to decrypt the DEK when access to the underlying data is needed. This separation of responsibilities between data encryption and key management reduces the likelihood that both the encrypted data and the keys required to decrypt it are exposed through a single point of compromise.

In some implementations, the cryptographic engine 102 may be used to manage and protect encryption material (e.g., DEK). For example, in a key management scenario, the cryptographic engine 102 of a server or user device may generate or receive a DEK, encrypt the DEK using a KEK, and store the encrypted DEK or transmit the encrypted DEK along with an encryption identifier, into the data repository 108.

The flexibility to protect plaintext data, encryption material (e.g., DEK), or both allows the cryptographic engine 102 to support a wide range of deployment models and security policies. Whether operating in a client-side, server-side, or hybrid environment, the system 200 can be adapted to meet the needs of applications that prioritize confidentiality, compartmentalization of key material, or distributed trust models. The modular architecture of the cryptographic engine 102, including components such as the encryption and decryption module 214 and other modules 218, supports this adaptability across various use cases and environments.

To enhance security, in some embodiments, the encryption and decryption module 214 may implement key rotation policies, periodically generating new keys and updating the stored keys. Additionally, in some embodiments, keys may have expiration dates, after which they are no longer valid, reducing the risk of long-term key exposure. In some embodiments, data encryption keys are rotated with every transaction, and stored with the transaction ID to decrypt. The key once used is never reused. Moreover, the encryption keys are not generated ahead of time.

The one or more modules 208 also comprises the signature generation and verification module 216, which is configured to ensure the authenticity and integrity of data transmitted between the one or more user devices. The signature generation and verification module 216 implements the digital signature concept to verify that data sent from the first user device 104 has not been altered in transit and that the data originated from a legitimate source.

In order to generate the digital signature, the signature generation and verification module 216 is configured to receive the data from the first user device 104 that needs to be authenticated. Upon receiving the data, the signature generation and verification module 216 is configured to generate the digital signature for the data. In some embodiments, in order to generate the digital signature, the signature generation and verification module 216 is configured to create a unique hash of the data using one or more cryptographic hash functions such as SHA-256. Upon creating the unique hash, the unique hash is encrypted with the first user's private key. The encrypted unique hash acts as the digital signature, which is unique to the data from the first user device 104.

In some embodiments, the signature generation and verification module 216 is configured to generate a transaction ID associated with the digital signature. The transaction ID helps to track and manage the digital signature and its corresponding data. In some embodiments, the transaction ID and a public key to decrypt the encrypted hash are stored securely in the data repository 108. The digital signature, the transaction ID, and the data, either as plain text or as encrypted data, are then transmitted to the first user device 104, who can forward them to the second user device 106. In some embodiments, the private key is immediately destroyed after generating the digital signature, thereby ensuring that the private key cannot be reused or compromised

In some embodiments, the signature generation and verification module 216 is configured to receive a verification request from the second user device 106. In some embodiments, the verification request is received when the second user device 106 receives the data, associated digital signature, and transaction ID from the first user device 104.

Upon receiving the verification request, the signature generation and verification module 216 is configured to retrieve the public key associated with the transaction ID from the data repository 108. The public key corresponds to the private key that is used to generate the digital signature.

Upon retrieving the public key, the signature generation and verification module 216 is configured to verify the digital signature using the retrieved public key. In order to verify the digital signature, the signature generation and verification module 216 is configured to decrypt the digital signature using the public key, thereby obtaining the original hash of the data. Further, the signature generation and verification module 216 is configured to generate a new hash of the received data using the same cryptographic hash function used during the signature generation. Upon generating the new hash and obtaining the original hash, the signature generation and verification module 216 is configured to compare the two hashes to verify the authenticity and integrity of the data. If the hashes match, the signature generation and verification module 216 may confirm that the data has not been altered and is indeed from the first user who owns the private key. In some embodiments, upon the hashes matching, the encryption and decryption module 214 may proceed to initiate the decryption of the encrypted data. If the hashes do not match, the signature generation and verification module 216 may provide an indication that the data may have been tampered with and the verification fails.

The one or more modules 208 may also comprise the other modules 218 to perform various miscellaneous functionalities of the cryptographic engine 102. It will be appreciated that such aforementioned modules may be represented as a single module or a combination of different modules. The modules may be implemented in the form of software implemented by a processor, hardware, and or firmware.

In some embodiments, the cryptographic engine 102 may optionally implement a key signing key (KSK) mechanism to support digital signature generation and verification. The KSK is a cryptographic key used to sign data or metadata associated with an encryption request, thereby enabling downstream recipients to verify the authenticity and integrity of the data. The KSK may be generated by the signature generation and verification module 216, either locally on the user device or remotely by the cryptographic engine 102, depending on the deployment model.

The KSK may be implemented as part of an asymmetric key pair, comprising a private key and a corresponding public key. The private key is used to generate a digital signature over a hash of the plaintext data, the encryption identifier, or other relevant metadata. Once the signature is generated, the private key is immediately destroyed to prevent reuse or compromise. This one-time-use model enhances security by ensuring that each signature is uniquely tied to a specific encryption event and cannot be forged or reused in future transactions.

The public key associated with the KSK is retained and stored in the data repository 108, along with a second encryption identifier (e.g., a signature transaction ID) that links the public key to the corresponding digital signature. This allows the cryptographic engine 102 or a recipient device to retrieve the public key and verify the digital signature during a subsequent authentication or decryption request. The verification process involves decrypting the digital signature using the public key and comparing the resulting hash with a newly computed hash of the received data. A match confirms that the data has not been altered and that it originated from a trusted source.

In some embodiments, the KSK mechanism may be used in conjunction with or independently of the permission access record described above. For example, even if a user has valid access credentials, the cryptographic engine 102 may require successful signature verification before decrypting the data.

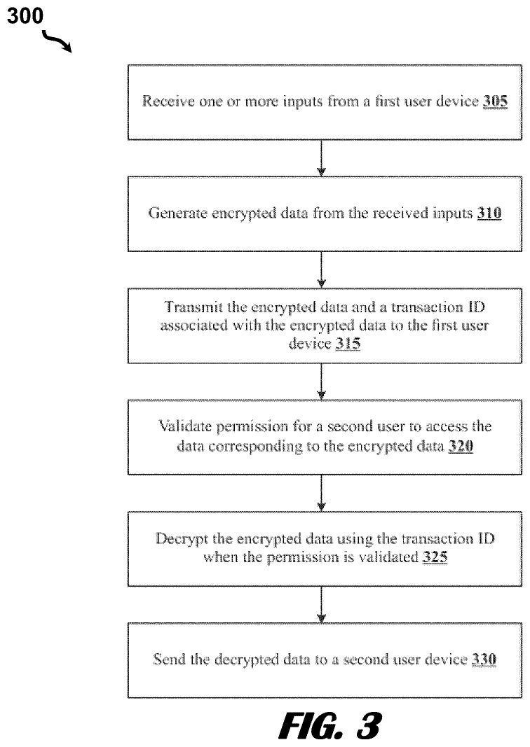

FIG. 3 is a flow diagram of an example secure data transmission method in accordance with some embodiments of the present disclosure. As illustrated in FIG. 3, the method 300 comprises one or more blocks implemented by the cryptographic engine 102. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 305, one or more user inputs are received from the first user device 104. In some embodiments, the user inputs may comprise various types of data requiring encryption. The one or more user inputs are received through the first user device 104 and processed by the cryptographic engine 102. In some embodiments, the one or more user inputs are received from the first user device 104 after a first user associated with the first user device 104 is registered with the cryptographic engine 102. In some embodiments, the one or more user inputs also comprise details of recipients who can access data from the first user device 104.

At block 310, encrypted data is generated from the received inputs. In some embodiments, the encrypted data is generated by the encryption and decryption module 214 from the received inputs. In some embodiments, the encrypted data is generated using an encryption algorithm. Upon generating the encrypted data, a unique transaction ID associated with the encrypted data and an encryption key used for the encryption are stored in the data repository 108.

At block 315, the encrypted data and the transaction ID are transmitted to the first user device 104 from the cryptographic engine 102. In some embodiments, the encrypted data and the transaction ID are then sent by the first user device 104 to the second user device 106 in a secure manner.

At block 320, permission for the second user to access the encrypted data is validated. In some embodiments, the permission for the second user to access the encrypted data is validated by the encryption and decryption module 214. In some embodiment, the permission is validated upon receiving the request from the second user device 106 to decrypt the encrypted data received. In some embodiments, the validation is performed by comparing the transaction ID received from the second user device 106 with one or more authorized users who can access the data against the transaction ID.

At block 325, the encrypted data is decrypted using the transaction ID when the permission is validated. In some embodiments, the encrypted data is decrypted by the encryption and decryption module 214 when the permission is validated. In some embodiments, a decryption key, which may be used to decrypt the encrypted data, is retrieved using the transaction ID, where the decryption key is stored against the transaction ID in the data repository 108. Upon retrieving the decryption key, the encrypted data is decrypted using the decryption key.

At block 330, the decrypted data is sent to the second user device 106. In some embodiments, the decrypted data is sent to the second user device 106 by the cryptographic engine 102. The decrypted data is sent to the second user device 106 after the decryption of the encrypted data from the cryptographic engine 102; thereby, only authorized users, such as the second user, may access the decrypted data that is sent from the first user device 104. Thus, the data integrity and confidentiality of the data are maintained when the data is sent from the first user device 104 to the second user device 106 or vice versa.

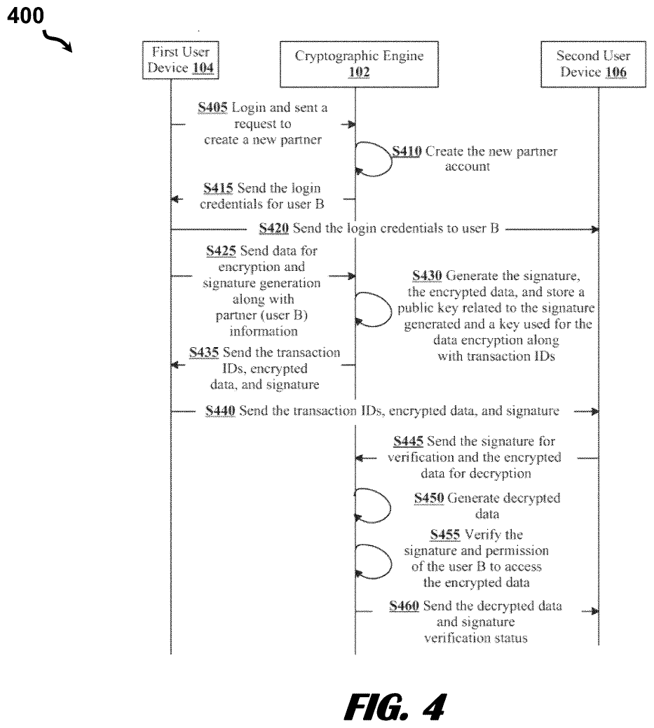

FIG. 4 shows a flowchart detailing the process of secure data transmission using the cryptographic engine 102 in accordance with some embodiments of the present disclosure.

At step 405, the first user, a registered user with the cryptographic engine 102, logs in with their login credentials and sends a request to create a new partner account for one or more second users (such as User B) through the first user device 104. In some embodiments, the request may specify permissions and access levels for the one or more second users, which may include defining which encrypted data the second user can access and what operations the one or more second users are allowed to perform (e.g., read, write, decrypt).

At step 410, the cryptographic engine 102 is configured to receive the request from the first user device 104 and processes the received request to create the new partner account for the second user. In some embodiments, the cryptographic engine generates necessary credentials and stores relevant information securely. In some embodiments, the second user is also provided with the necessary permission and access as specified by the first user in the request from the first user device 104.

At step 415, the cryptographic engine 102 sends the login credentials for the second user to the first user device 104 securely, which is sent to the second user device 104 from the first user device 104.

At step 420, the first user device 104 communicates the login credentials directly to the second user device 106, ensuring that the second user device 104 associated with the second user has the necessary information to access their new account. In some embodiments, the login credentials may comprise a username and a temporary password. The second user may then use these credentials for the first time and set up their own secure password.

At step 425, the first user device 104 sends data for encryption and signature generation, along with partner information related to the second user, to the cryptographic engine 102. In some embodiments, the first user device 104 may be provided with an option to select either just an encryption operation or both encryption and signature generation on the data.

At step 430, the cryptographic engine 102 generates the digital signature for the data and encrypts the data based on the first user device 104 selection at step 425. In some embodiments, an encryption key used to encrypt the data is stored along with a first transaction ID in the data repository 108. The first transaction ID acts as a unique identifier for the encrypted data. Similarly, in some embodiments, a public key associated with a private key used to generate the digital signature is stored along with a second transaction ID in the data repository. In some embodiments, the private key is immediately destroyed after generating the digital signature, thereby ensuring that the private key cannot be reused or compromised.

At step 435, the cryptographic engine 102 sends the first and second transaction IDs, encrypted data, and the generated signature to the first user device 104.

At step 440, the first user device 104 sends the first and second transaction IDs, encrypted data, and the signature to the second user device 106, enabling the second user device 106 to proceed with data decryption and signature verification.

At step 445, the second user device 106 sends the signature for verification and the encrypted data for decryption to the cryptographic engine 102.

At step 450, the cryptographic engine 102 generates the decrypted data, making it accessible to User B. In some embodiments, the cryptographic engine 102 may retrieve the encryption key stored along with the first transaction ID and decrypt the encrypted data using the encryption key.

At step 455, the cryptographic engine 102 verifies the digital signature and checks the permission of the second user to access the encrypted data. This ensures that the second user is authorized to view the data. Further, based on the received second transaction ID, the cryptographic engine 102 retrieves the public key stored along with the second transaction ID and validates the digital signature using the public key.

At step 460, upon successful verification, the cryptographic engine 102 sends the decrypted data and the signature verification status to the second user device 106. This final step completes the secure transaction, ensuring data integrity and confidentiality. Although in FIG. 4, the data transmission is shown from the first user device 104 to the second user device 106, the second user device 106 may also send the data conversely using steps similar to those above.

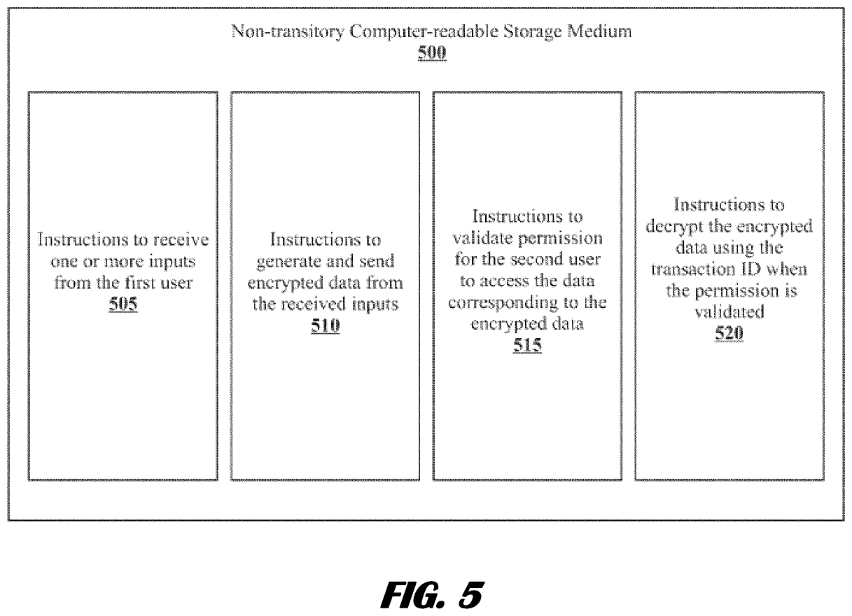

Turning now to FIG. 5, an example non-transitory computer-readable storage medium (CRSM) 500 is shown, in which CRSM 500 comprises instructions executable by the processor 202. The CRSM 500 may comprise any electronic, magnetic, optical, or other physical storage device that stores executable instructions. The instructions may comprise instructions to cause the processor to perform or control performance of operations of the example method 300 and the other methods described herein. For example, the instructions may comprise instructions 505 to receive one or more inputs from the first user device 104.

In addition, the instructions may comprise instructions 510 to generate and send encrypted data from the received inputs. Furthermore, the instructions may comprise instructions 515 to validate permission for the second user to access the data corresponding to the encrypted data. Furthermore, the instructions may comprise instructions 520 to decrypt the encrypted data using a transaction ID when the permission is validated.

The methods described herein may be performed using the systems described herein. In addition, it is contemplated that the methods described herein may be performed using systems different than the systems described herein. Moreover, the systems described herein may perform the methods described herein and may perform or execute the instructions stored in the CRSMs described herein. It is also contemplated that the systems described herein may perform functions or execute instructions other than those described in relation to the methods and CRSMs described herein.

Furthermore, the CRSMs described herein may store instructions corresponding to the methods described herein and may store instructions which may be performed or executed by the systems described herein. Furthermore, it is contemplated that the CRSMs described herein may store instructions different than those corresponding to the methods described herein and may store instructions which may be performed by systems other than the systems described herein.

The methods, systems, and CRSMs described herein may include the features or perform the functions described herein in association with any one or more of the other methods, systems, and CRSMs described herein.

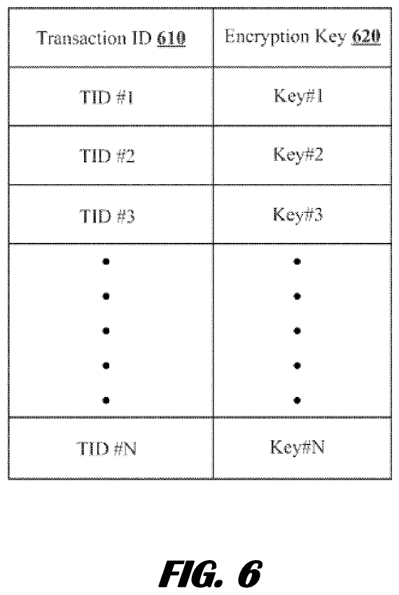

FIG. 6 shows an exemplary table record stored in a database in accordance with some embodiments of the present disclosure. As shown in FIG. 6, the database is configured to store a unique encryption key 620 (such as Key #1, Key #2, . . . , Key #N) used to encrypt the data or decrypt the encrypted data. Further, the database is also configured to create a unique transaction ID 610 (TID #1, TID #2, . . . , TID #N) that acts as a unique identifier for each data that is encrypted, and the created unique transaction ID is stored along with the corresponding encryption key 620 as a single record.

As shown in FIG. 6, TID #1 is linked with Key #1, TID #2 is linked with Key #2, and so forth, up to TID #N linked with Key #N. This structured pairing ensures that each transaction uses a unique key, thereby enhancing the security and integrity of data transmissions within the cryptographic engine 102. In some embodiments, the database may be part of the data repository 108 or the memory 204 of the cryptographic engine 102.

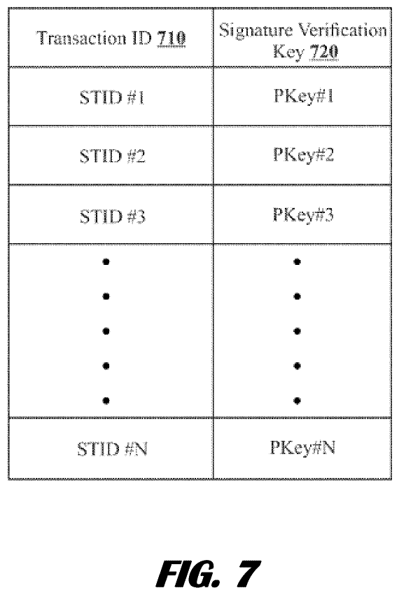

FIG. 7 shows another exemplary table record stored in a database in accordance with some embodiments of the present disclosure. As shown in FIG. 7, the database is configured to store a signature verification key 720 (such as PKey #1, PKey #2, . . . , PKcy #N) that may be used to validate the generated digital signature. Further, the database is also configured to create a unique transaction ID 710 (STID #1, STID #2, . . . , STID #N) that acts as a unique identifier for each data that is digitally signed, and the created unique transaction ID is stored along with the corresponding signature verification key (i.e., public key) 720 as a single record.

As shown in FIG. 7, STID #1 is paired with PKey #1, STID #2 with PKey #2, and so on, continuing in this manner up to STID #N with PKey #N. This configuration enhances the security of the cryptographic system, as each transaction is signed using a unique private key which has a corresponding unique public key (PKey), thereby facilitating secure and verified data exchanges. In some embodiments, the database may be part of the data repository or a memory of the cryptographic engine 102. The public key stored in each record corresponds to a private key that is used to generate the digital signature for the data associated with the corresponding transaction ID.

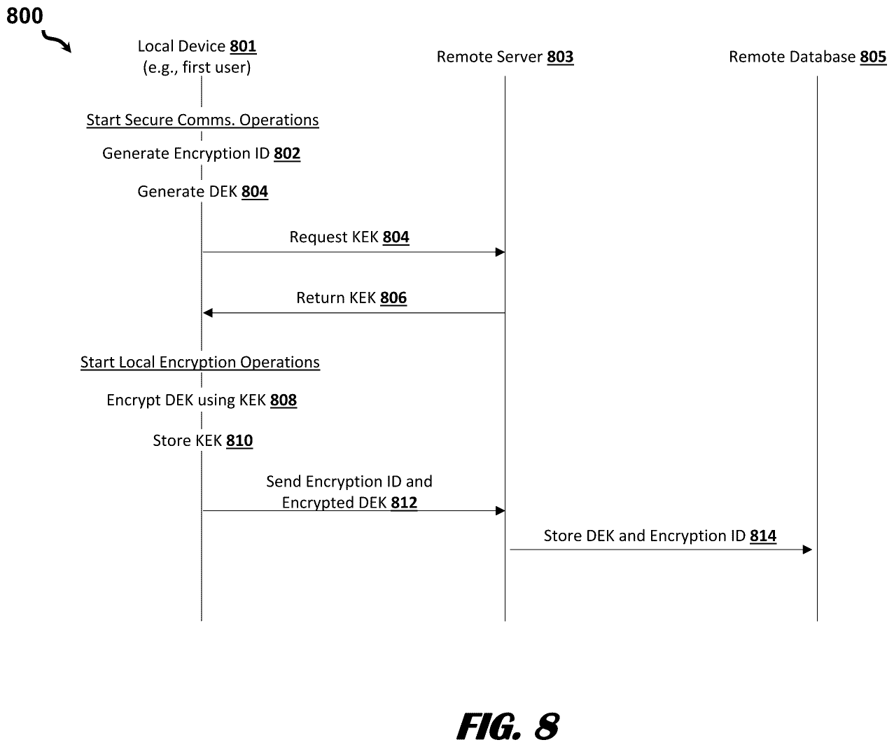

FIG. 8 is a flowchart of an example method 800 for secure data transmission between a first user device and a second user device. The operations of the method 800 may be performed by a computing device (e.g., server, first user device, second user device) having at least one processor executing a cryptographic engine (e.g., cryptographic engine 102, encryption and decryption module 214) or similar software component. In some embodiments, the cryptographic engine may be executed locally on the first user device, such as within a browser environment using WebAssembly or similar technology.

A local computing device 801 (e.g., cryptographic engine 102 of a server, first user device 104, second user device 106) initiates secure communications operations. This may include initializing a cryptographic engine or application module configured to perform encryption and key management tasks, with or without transmitting plaintext data to a remote server 803.

At operation 802, the local device 801 generates a unique encryption identifier (also referred to as a transaction ID or encryption request ID). This encryption identifier serves as a reference for the encryption request and is used to associate the encrypted data with corresponding cryptographic keys. The encryption identifier may be generated using a UUID, hash function, or other entropy-rich mechanism.

At operation 804, the local device 801 generates a data encryption key (DEK). The DEK is used to encrypt the plaintext data locally. In some embodiments, the DEK is a symmetric key (e.g., AES-256), although asymmetric encryption may also be supported.

At operation 806, the local device 801 sends a request to a remote server 803 for a key encryption key (KEK). The KEK is used to encrypt the DEK before the KEK is transmitted over a network or stored at any remote location, such as a remote database 805 associated with the remote server 803. In some embodiments, the KEK may be provisioned by the remote server 803 or generated locally by the local device 801, according to the implementation.

At operation 808, the local device 801 encrypts the DEK using the KEK. By encrypting the DEK using the KEK, the DEK is protected before being transmitted to or stored in a manner that any plaintext data is accessible to either the remote server 803, the remote database 805, or any other device. The encryption of the DEK may be performed using symmetric or asymmetric cryptographic techniques. Following this operation 808 of encrypting the DEK using the KEK, the plaintext DEK is discarded from memory to reduce the risk of exposure. If a digital signature is generated during the encryption process (as in the method 800), the signing private key used for signing is destroyed immediately after use.

At operation 810, the local device 801 stores the KEK locally on a non-transitory storage coupled to the local device 801. This allows the local device 801 to later decrypt the DEK if needed, without requiring access to the plaintext DEK from the remote server 803.

At operation 812, the local device 801 sends the encryption identifier and the encrypted DEK to the remote server 803. The local device 801 may transmit only the encrypted DEK and the associated encryption identifier to the remote server 803, and need not transmit the KEK to the remote server 803 or the plaintext data. This configuration prevents third-party access to the plaintext data and DEK. For instance, the remote server 803 and remote database 805 would be unable to access the encrypted DEK or encrypted ciphertext of the original plaintext data. Recovery of the original plaintext data remains possible by retrieving the encrypted DEK using the encryption identifier and decrypting the DEK locally using the KEK.

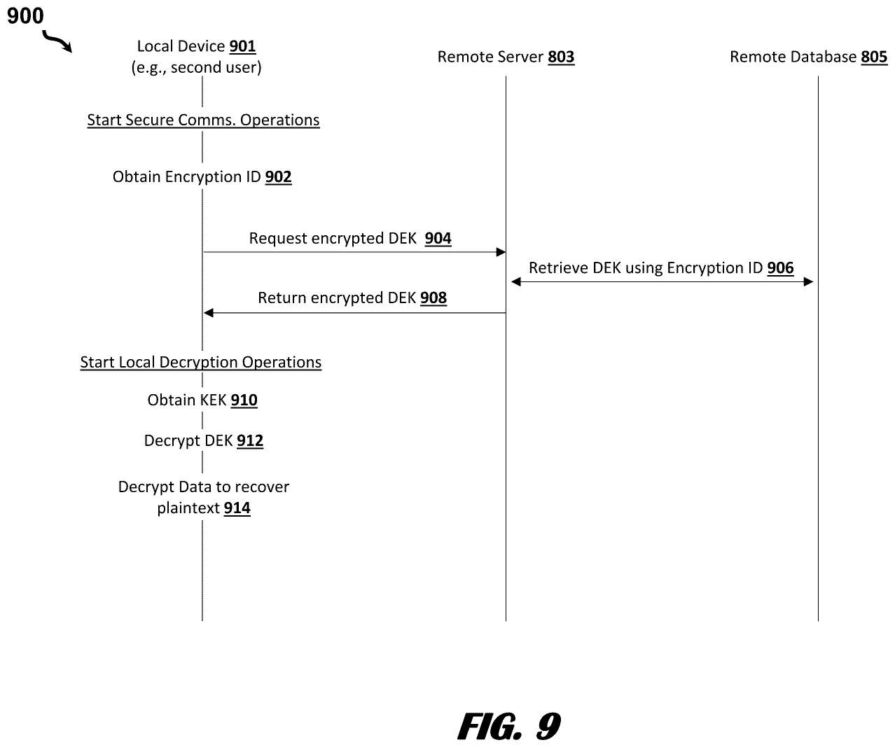

At operation 814, the remote server 803 stores the encrypted DEK and the associated encryption identifier into the remote database 805. In future decryption or retrieval operations (such as the method 900 of FIG. 9), the decryption operations may be performed by retrieving the relevant types of encrypted data using the corresponding encryption identifier, without requiring access to the plaintext data or other types of encryption material.

FIG. 9 is a flowchart of an example method 900 for retrieving and decrypting encrypted data to recover the original plaintext in accordance with some embodiments of the present disclosure. The operations of method 900 may be performed by a computing device (e.g., a local user device or server) executing a cryptographic engine, such as the cryptographic engine 102 described in FIG. 2. In some embodiments, the cryptographic engine may be executed locally on the second user device, such as within a browser environment using WebAssembly or similar technology.

A local device 901 (e.g., second user device) initiates a secure local communications and decryption operation. This may include launching a cryptographic engine or application module configured to retrieve encrypted data (e.g., encryption keys, plaintext data, metadata) and perform decryption locally.

At operation 902, the local device 901 obtains (e.g., receives, retrieves) the encryption identifier (e.g., transaction ID or encryption request ID) and the encrypted data encryption key (DEK). These may have been previously transmitted from another user device (e.g., local device 801, first user device 104) or retrieved from a management server 803 or secure database 805.

At operation 904, the local device 901 transmits a request to the remote server 803 for the encrypted DEK, using the encryption identifier as a reference. The encrypted DEK was previously generated and stored into the remote database 805 during an encryption phase (as in the method 800 of FIG. 8).

At operation 906, the remote server 803 queries the remote database 805 using the encryption identifier and retrieves the encrypted DEK using the associated encryption identifier.

At operation 908, the remote server 803 transmits and returns the encrypted DEK and encryption identifier to the local device 901. The remote server retrieves only the encrypted DEK and its associated encryption identifier from the remote database, without accessing unencrypted keys, encrypted keys (e.g., encrypted KEK), unencrypted original plaintext, or encrypted ciphertext of the original plaintext data. The remote server may return only the encrypted DEK and any metadata (e.g., encryption identifier).

At operation 910, the local device 901 retrieves a key encryption key (KEK) from local storage. The KEK was previously obtained or stored, which may have occurred during the encryption phase (as in the method 800 of FIG. 8) and required to decrypt the DEK.

At operation 912, the local device 901 decrypts the encrypted DEK using the KEK. This operation recovers the original DEK, which the local device 901 then uses to decrypt the actual encrypted ciphertext data of the original plaintext data. This separation of key material and encrypted data inhibits the potential for unauthorized access. Despite the deletion of plaintext data and destruction of any signing keys during the method 800 of the encryption phase, the original DEK can be reconstructed using the KEK, allowing the encrypted data to be decrypted and the plaintext to be recovered.

At operation 914, the local device 901 uses the now-decrypted, recovered DEK to decrypt the encrypted ciphertext data. This operation restores the original plaintext data that was encrypted during the method 800 of FIG. 8. The plaintext data is made available to a user interface or application on the local device 901. This may include displaying the plaintext data, storing the plaintext data locally, or passing the plaintext to another application for further processing.

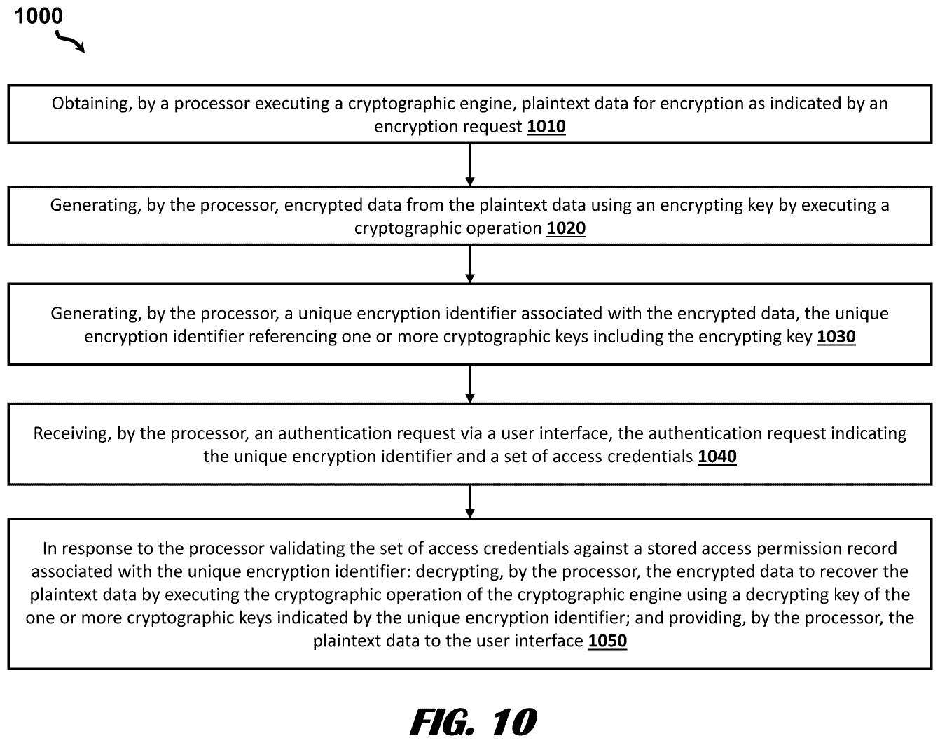

FIG. 10 is a flowchart of an example method 1000 for secure data transmission between a first user device and a second user device. The operations of the method 1000 may be performed by a computing device (e.g., server, first user device, second user device) having at least one processor executing a cryptographic engine (e.g., cryptographic engine 102, encryption and decryption module 214) or similar software component. In some embodiments, the cryptographic engine may be executed locally on the first user device, such as within a browser environment using, for example, WebAssembly or similar technology.

At operation 1010, a processor obtains (e.g., receives, retrieves) plaintext data for encryption as indicated by an encryption request. In some embodiments, the plaintext data may be accompanied by metadata identifying one or more intended recipients or authorized users. The encryption request may originate from a user interface or application executing on the first user device.

At operation 1020, the processor generates encrypted data from the plaintext data using an encrypting key by executing a cryptographic operation of the cryptographic engine. The cryptographic operation may include symmetric encryption (e.g., AES) or asymmetric encryption using a private key of a key pair. In some embodiments, the encrypting key and decrypting key are the same symmetric key (e.g., AES-256), while in other embodiments, the encrypting key is a private key and the decrypting key is a corresponding public key.

At operation 1030, the processor generates a unique encryption identifier (e.g., transaction ID) associated with the encrypted data. The unique encryption identifier references one or more cryptographic keys, including the encrypting key. In some embodiments, the processor may store the encryption identifier and the encrypting key in a data repository for later retrieval. The encryption identifier may be generated using a random number generator, a hash function, or a combination of user-specific and system-generated data.

At operation 1040, the processor receives an authentication request via a user interface. The authentication request includes the unique encryption identifier and a set of access credentials. In some embodiments, the authentication request may also include a digital signature generated using a private key, which may be verified using a corresponding public key.

At operation 1050, in response to the processor validating the set of access credentials against a stored access permission record associated with the unique encryption identifier, the processor decrypts the encrypted data to recover the plaintext data by executing the cryptographic operation of the cryptographic engine using a decrypting key of the one or more cryptographic keys indicated by the unique encryption identifier. In some embodiments, the decrypting key may be retrieved from a data repository based on the encryption identifier. The processor then provides (e.g., transmits, displays) the plaintext data to the user interface. In some embodiments, the decrypted data is transmitted from the first user device to the second user device via a secure communication channel. In some cases, the operation 1050 may include decrypting the encrypted data using a decrypting key and providing the resulting plaintext data to a user interface. Certain encryption keys and/or plaintext data used for digital signatures may be destroyed to prevent reuse or access. For instance, the plaintext data need not be transmitted, stored, or otherwise retained at another device (e.g., database) beyond the local device. The use of the unique encryption identifier allows retrieval of the encrypted DEK, and the KEK retained by the authorized user enables decryption of the DEK, which is then used to decrypt the encrypted plaintext data. This structure supports recovery of the original plaintext data while limiting the exposure of sensitive cryptographic material and/or the plaintext data.

The above description of shown example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In some embodiments, the method or methods described above may be executed or carried out by a computing system (for example, the cryptographic engine 102) including a tangible computer-readable storage medium, also described herein as a storage machine, that holds machine-readable instructions executable by a logic machine (e.g., a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an API.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for secure data transmission between user devices, the method comprising:
obtaining, by a processor executing a cryptographic engine, plaintext data for encryption as indicated by an encryption request;
generating, by the processor, encrypted data from the plaintext data using an encrypting key by executing a cryptographic operation;
generating, by the processor, a unique encryption identifier associated with the encrypted data, the unique encryption identifier referencing one or more cryptographic keys including the encrypting key;
receiving, by the processor, an authentication request via a user interface, the authentication request indicating the unique encryption identifier and a set of access credentials;
in response to the processor validating the set of access credentials against a stored access permission record associated with the unique encryption identifier:
decrypting, by the processor, the encrypted data to recover the plaintext data by executing the cryptographic operation of the cryptographic engine using a decrypting key of the one or more cryptographic keys indicated by the unique encryption identifier; and
providing, by the processor, the plaintext data to the user interface.

2. The method of claim 1, further comprising storing, by the processor, the unique encryption identifier and the encrypting key in a data repository.

3. The method of claim 1, further comprising retrieving, by the processor, the decrypting key from a data repository based on the unique encryption identifier as indicated by the authentication request.

4. The method of claim 1, wherein the encrypting key and the decrypting key are a same symmetric key.

5. The method of claim 4, wherein the cryptographic operation comprises an Advanced Encryption Standard (AES) algorithm.

6. The method of claim 1, wherein the encrypting key is a private key of an asymmetric key pair and the decrypting key is a public key of the asymmetric key pair.

7. The method of claim 1, further comprising
generating, by the processor, a digital signature for the plaintext data using a private key; and
deleting, by the processor, the private key after the digital signature is generated.

8. The method of claim 1, wherein the authentication request includes a digital signature, and wherein validating the set of access credentials includes verifying, by the processor, the digital signature of the authentication request using a public key associated with a private key.

9. The method of claim 1, wherein the processor executing the cryptographic engine is executed on a first user device.

10. The method of claim 1, wherein the encrypted data is transmitted from a first user device to a second user device via a secure communication channel.

11. A system for secure data transmission between user devices, the system comprising:
a processor configured to:
obtain plaintext data for encryption as indicated by an encryption request;
generate encrypted data from the plaintext data using an encrypting key by executing a cryptographic operation;
generate a unique encryption identifier associated with the encrypted data, the unique encryption identifier referencing one or more cryptographic keys including the encrypting key;
receive an authentication request via a user interface, the authentication request indicating the unique encryption identifier and a set of access credentials;
in response to validating the set of access credentials against a stored access permission record associated with the unique encryption identifier:
decrypt the encrypted data to recover the plaintext data by executing the cryptographic operation using a decrypting key of the one or more cryptographic keys indicated by the unique encryption identifier; and
provide the plaintext data to the user interface.

12. The system of claim 11, wherein the processor is further configured to store the unique encryption identifier and the encrypting key in a data repository.

13. The system of claim 11, wherein the processor is further configured to retrieve the decrypting key from a data repository based on the unique encryption identifier as indicated by the authentication request.

14. The system of claim 11, wherein the encrypting key and the decrypting key are a same symmetric key.

15. The system of claim 14, wherein the cryptographic operation comprises an Advanced Encryption Standard (AES) algorithm.

16. The system of claim 11, wherein the encrypting key is a private key of an asymmetric key pair and the decrypting key is a public key of the asymmetric key pair.

17. The system of claim 11, wherein the processor is further configured to:
generate a digital signature for the plaintext data using a private key; and
delete the private key after the digital signature is generated.

18. The system of claim 11, wherein the authentication request includes a digital signature, and wherein the processor is further configured to validate the set of access credentials by verifying the digital signature using a public key associated with a private key.

19. The system of claim 11, wherein the processor executing a cryptographic engine is located on a first user device.

20. The system of claim 11, wherein the encrypted data is transmitted from a first user device to a second user device via a secure communication channel.
